(19) United States
(12) Patent Application Publication
(10) Pub. No.: US 2024/0028341 A1
(43) Pub. Date: Jan. 25, 2024

(54) GALOIS FIELD MULTIPLY REDUCTION AND PARALLEL HASH

(71) Applicant: Intel Corporation, Santa Clara, CA (US)

(72) Inventors: Erdinc OZTURK, Paris (FR); Kirk S. YAP, Westborough, MA (US); Tomasz KANTECKI, Ennis (IE)

(21) Appl. No.: 18/375,476

(22) Filed: Sep. 30, 2023

Related U.S. Application Data
(60) Provisional application No. 63/454,017, filed on Mar. 22, 2023.

(51) Int. Cl. G06F 9/38

(52) U.S. Cl. CPC G06F 9/3887; G06F 9/3877

(57) ABSTRACT

Examples described herein relate to a non-transitory computer-readable medium comprising instructions, that if executed by circuitry, cause the circuitry to: configure circuitry to perform cryptographic operations on packets based on Advanced Encryption Standard with Galois/Counter Mode (AES-GCM) hash (GHASH), wherein the cryptographic operations comprise a reduction operation and wherein the reduction operation comprises a single Galois territory multiplication 64 bit operation. The circuitry can include one or more of: a central processing unit (CPU), CPU-executed microcode, an accelerator, or a network interface device.

### RELATED APPLICATION

This application claims priority to U.S. Provisional Application No. 63/454,017, filed Mar. 22, 2023. The entire contents of those applications are incorporated by reference in their entirety.

### DESCRIPTION

Advanced Encryption Standard with Galois/Counter Mode (AES-GCM) is a cipher suite and is used at least for encryption of packet transmissions via Transport Layer Security (TLS) and Internet Protocol Security (IPsec) connections. GCM involves encryption and authentication. Data is encrypted via an AES block cipher and an authentication tag is generated by applying a hash function (GHASH) to the ciphertext. McGrew and Viega, “The Galois/Counter Mode of Operation (GCM),” Submission to National Institute of Standards and Technology (NIST) (January 2004) describes an example manner of performing GHASH to provide a result of X, based on the following equation (equation (2) in the submission):

$${X}_{i} = \{ \begin{matrix}0 & for i = 0 \\ ( {X}_{i - 1} ⊕ {A}_{i} ) \cdot H & for i 1 , … , m - 1 \\ ( {X}_{m - 1} ⊕ ( {A}_{m}^{*} ‖ {0}^{128 - v} ) ) \cdot H & for i = m \\ ( {X}_{i - 1} ⊕ {C}_{i} ) \cdot H & for i = m + 1 , … , m + n - 1 \\ ( {X}_{m + n - 1} ⊕ ( {C}_{m}^{*} ‖ {0}^{128 - u} ) ) \cdot H & for i = m + n \\ ( {X}_{m + n} ⊕ ( len ( A ) ‖ len ( C ) ) ) \cdot H & for i = m + n + 1.\end{matrix}$$

To decrease a number of operations to perform GHASH per encrypted message, pre-computed hash key powers per established connection can be utilized. When processing a message, to lower a number of Galois Field (GF) reduce operations per message, pre-computed hash key powers can be multiplied against adequate message blocks, the products added together, followed by application of a reduction operation. The latency of the reduction operation reduces AES-GCM performance by increasing latency and/or resources used for performance of AES-GCM.

### BRIEF DESCRIPTION OF THE DRAWINGS

FIG. 1 depicts a known example operation for multiplication in GF(2¹²⁸).

FIG. 2 depicts an example of operations for multiplication in GF(2¹²⁸) that utilizes a single operation for reduction.

FIG. 3 depicts a known example of GF(2¹²⁸) multiplication with bit reflected operands.

FIG. 4 depicts an example of a bit-reflected multiplication operation.

FIG. 5 depicts an example GHASH operation with 12 ciphertext blocks (Ci).

FIG. 6 depicts GHASH as a serial operation.

FIG. 7 depicts a GHASH operation.

FIG. 8 depicts an example process.

FIG. 9 depicts an example network interface device.

FIG. 10 depicts an example computing system.

### DETAILED DESCRIPTION

Various examples attempt to reduce a time to perform GHASH operations, circuitry to perform GHASH operations, and/or power utilized to perform GHASH operations. GHASH operations can involve multiplication and reduction operations. In some examples, in a GHASH operation, a folding operation can be performed to reduce a number of serial operations of a reduction operation in multiplication in GF(2¹²⁸). In some examples, for a GHASH operation over bit-reflected operands, for a reduction operation, a single Galois territory multiplication (GFMUL) 64 bit instruction (GFMUL64) execution can be performed. For example, GMUL64 can be consistent with Intel® 64 and IA-32 Architectures or utilized by processors that execute other instruction set architectures (e.g., Advanced RISC Machines (ARM) instruction set or Power 9 instruction set). In some examples, GFMUL can be performed by execution of: Intel® AES-NI PCLMULQDQ, ARM VMULL.P8, Power 9 Vector Polynomial Multiply-Sum (e.g., VPMSUMD), or others. Various examples provide for the GHASH operation to be offloaded to one or more of: a central processing unit (CPU), CPU-executed microcode, an offload circuitry accessible to a process executed by the CPU (e.g., accelerator), network interface device, or other circuitry. While example description is provided with respect to encryption operations, examples can be applied to decryption operations such as GHASH for GCM decryption for ciphertext hashing.

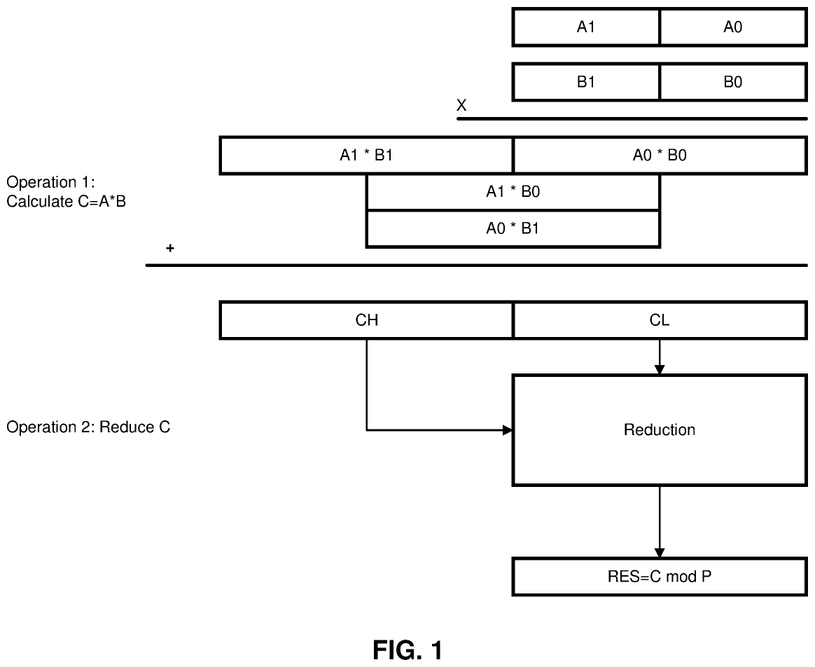

FIG. 1 depicts a known example operation for multiplication in GF(2¹²⁸). GHASH performs multiplication in the Galois Field, GF(2¹²⁸), which can be defined by the polynomial: P(x)=x¹²⁸+x⁷+x²+x+1, where x represents a bit position. Modular multiplication involves multiplication and reduction. Inputs can include A, B∈GF(2¹²⁸). Operation 1 can compute C=A*B whereas Operation 2 can compute RES=C modulo P. An output can include result (RES)=A*B mod P. In some examples, P(x) polynomial can represent a binary number and a coefficient can be either 0 or 1. In some examples, P=0x1 0000 0000 0000 0000 0000 0000 0000 0087.

In Operation 1, multiplication can generate C=A*B. C=A*B is illustrated with four 64×64 field multiplications. In some examples, a single Intel® AES-NI PCLMULQDQ instruction realizes a 64 bit Galois territory multiplication (GFMUL) operation (GFMUL64). Accordingly, Operation 1 can be performed by execution of four Intel® AES-NI PCLMULQDQ instructions. Operations such as CLMUL (carryless multiply), or any 64-bit carryless multiplication operation can be performed in addition to, or as an alternative to PCLMULQDQ. A carryless multiply operation can compute the product of two operands without the generation or propagation of carry values (arithmetic modulo 2). For example, in addition to, or as an alternative to PCLMULQDQ, one or more of the following instructions can be executed: ARM VMULL.P8, Power Instruction Set Architecture (ISA) (e.g., Power 9) Vector Polynomial Multiply-Sum (e.g., VPMSUMD).

In Operation 1, C=A*B is calculated as follows: C=A1*B1*x¹²⁸ A1*B0*x⁶⁴+A0*B1*x⁶⁴+A0*B0. Because Q=x⁷+x²+x+1 (x¹²⁸ mod P), a precomputed constant K can be as follows: K=B1*x¹²⁸ mod P(x)=B1*Q. Hence, equation for C can be rewritten as: C=A1*K+A1*B0*x⁶⁴+A0*B1*x⁶⁴+A0*B0. Because K=K1*x⁶⁴+K0:

C=A1*K1*x⁶⁴+A1*K0+A1*B0*x⁶⁴+A0*B1*x⁶⁴+A0*B0

C=A1*(K1+B0)*x⁶⁴+A1*K0+A0*B1*x⁶⁴+A0*B0

With this change, K=B1*Q+B0*x⁶⁴

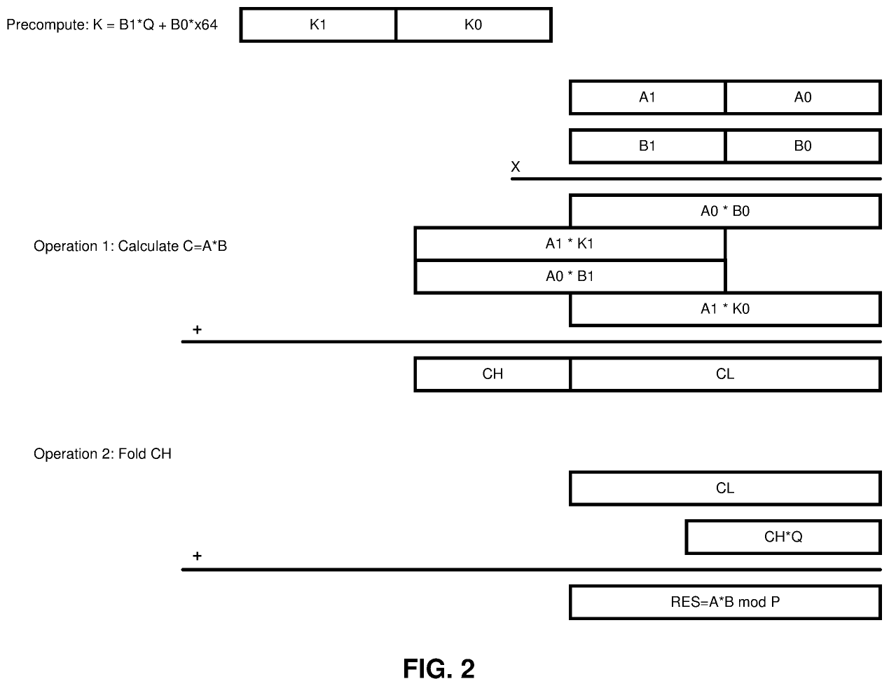

In Operation 2, for the reduction operation, two serial operations can be performed. The reduction operation can perform Barrett reduction, Montgomery reduction, a folding technique, or other operations. To remove one of the serial operations of the reduction operation in multiplication in GF(2¹²⁸), as described herein, a folding operation can be performed. Utilizing this approach, the result (RES) for multiplication in GF(2¹²⁸) can be performed as RES(x)=A(x)*B(x) modulo P(x) operation, which can be expressed as described with respect to FIG. 2.

FIG. 2 depicts an example of operations for multiplication in GF(2¹²⁸) that utilizes a single operation for reduction. For multiplication in GF(2¹²⁸), instead of four GFMUL64 operations, followed by two non-parallelizable steps, four GFMUL64 operations can be followed by one GFMUL64 operation for reduction. Inputs can include A, B∈GF(2¹²⁸), P(x)=x¹²⁸+x⁷+x²+x+1, and precomputed K=B1*Q+B0*x⁶⁴. In some examples, x can represent a bit position. In FIG. 2, K1 can represent upper (most significant) 64 bits of K and K0 can represent a lower (least significant) 64 bits of K.

Operation 1 can include computing C=A*B, where:

A=A1*x⁶⁴+A0,

B=B1*x⁶⁴+B0,

K=K1*x⁶⁴+K0,

A0B0=GFMUL64(A0,B0),

A0B1=GFMUL64(A0,B1),

A1K0=GFMUL64(A1,K0), and

A1K1=GFMUL64(A1,K1).

In other words, C=A1K1*x⁶⁴+A0B1*x⁶⁴+A0B0+A1K0 and can be a 192-bit number. In another expression, C=CH*x¹²⁸+CL, where CH=upper 64 bits of C and CL=lower 128 bits of C.

Operation 2 can include performance of Fold CH and RES=GFMUL64(CH, Q)+CL. Fold CH can perform CL+CH*Q. A folding operation can be performed at least in accordance with Gopal, Vinodh et al., “Fast and Constant-Time Implementation of Modular Exponentiation” (2009). To diminish the expense of modular reduction operations, a Barrett modular reduction can be performed to estimate a quotient, q=floor(floor(N/2^{m})μ/M), where m is the width of modulus M and μ is a constant determined by: 11=floor(2²ⁿ/M), where n is the width of number N. The value of N mod M can then be determined by computing N−qM, followed by a final subtraction by M if necessary to ensure the final value is less than M. Contributing to Barrett's efficiency is the ability to access a pre-computed value for μ. That is, the value of μ can be determined based only on the size of N without access to a particular value of N.

To diminish the computational cost of modular reduction, a folding operation can be performed on a number N into a smaller width number N′. Despite the smaller width, the folding operation determines N′ such that N′ mod M is the same as N mod M. An operation, such as a Barrett modular reduction, can then operate on the smaller N′. By shrinking the operand N, subsequent operations involve smaller sized numbers, which can reduce the multiplications used to determine a modular remainder. In addition, the larger the number N, the more pronounced the efficiency becomes.

Operation 2 can provide an output of RES=A*B modulo P. In some examples, as defined by GHASH standard, P=x¹²⁸+x⁷+x²+x+1.

For GHASH computations, GCM specifies use of bit-reflected operands. A bit-reflected operand can be in accordance at least with Gueron, Shay and Kounavis, Michael, “Intel® Carry-Less Multiplication Instruction and its Usage for Computing the GCM Mode” (April 2014).

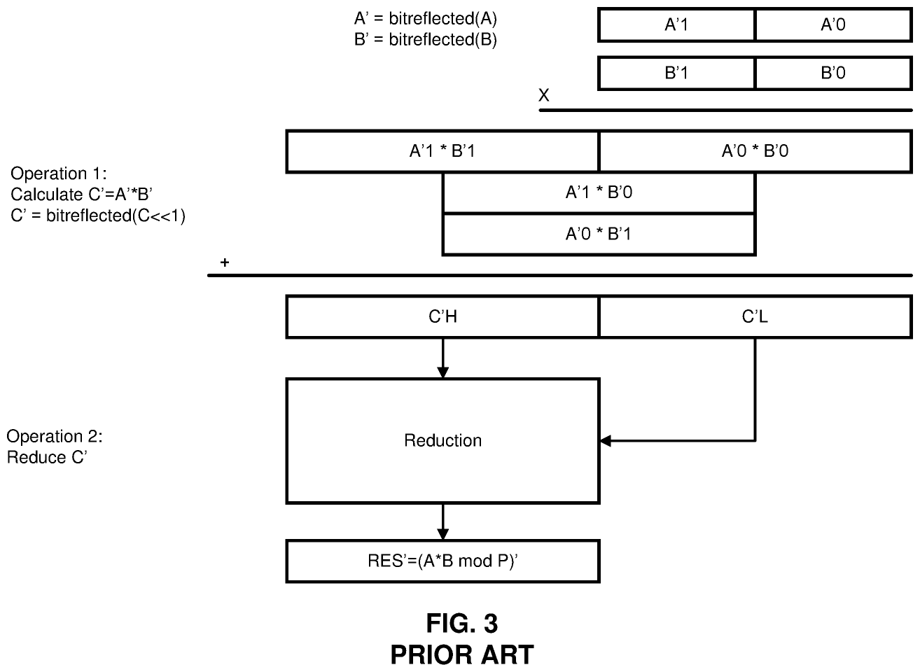

FIG. 3 depicts a known example of GF(2¹²⁸) multiplication with bit reflected operands. In some examples, inputs are A′ and B′ and an output can be RES′. A′ can correspond to values that are multiplied by H whereas B′ can correspond to H and can represent a precomputed encrypted value. A bit-reflection function can be defined as: bitreflectᵢ(X)=X′, where input X is treated as an i-bit value that is bit-reflected. GHASH utilizes bit-reflected inputs: X′=bitreflect₆₄(X) and Y′=bitreflect₆₄(Y). For example, with respect to FIG. 3, X′ and Y′ can represent respective A′ and B′.

Intel® PCLMULQDQ instructions can be executed by processors with bit-reflected operands with precomputation steps to eliminate bit-reflection and reduce time to complete GHASH computations. Execution of PCLMULQDQ performs GFMUL64(X,Y)=X*Y. Accordingly, GFMUL64(X′,Y′)=bitreflect₁₂₈(Z<<1), where Z=GFMUL64(X, Y) and <<represents a left shift operation by 1 bit placement. GFMUL128 can utilize a 128-bit multiplier to perform RES'=bitreflect₁₂₈(A*B mod P). In another expression, GFMUL64(bitreflected(Y), bitreflected(Z))=bitreflected(X<<1), where X=GFMUL64(Y, Z).

In Operation 1, a determination of C′=A′*B′ can be performed, and C′ can represent bitreflected(C<<1). In Operation 2, reduction can be performed followed by determination of RES′. Reduction can utilize two serial operations that include an operation involving modulo P(x). RES′ can correspond to determination of Xi, described with respect to equation (2) of GCM, where i can represent a counter of encrypted cipher text blocks.

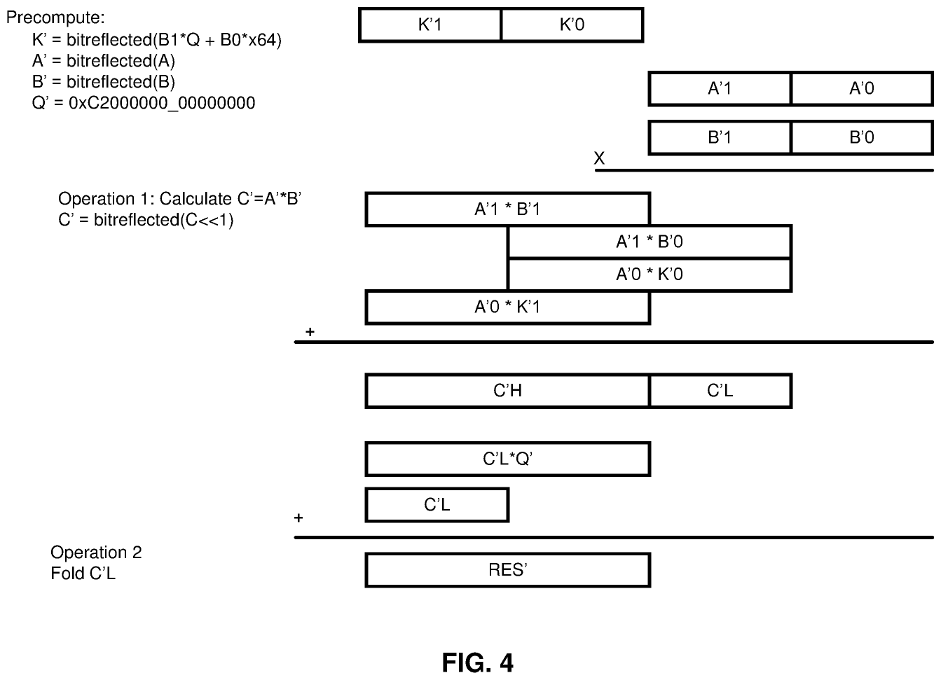

FIG. 4 depicts an example of a bit-reflected multiplication operation. For a GHASH standard defined over bit-reflected operands, instead of four GFMUL64 operations followed by three GFMUL64 operations for reduction with two non-parallelizable steps, as described herein, four GFMUL64 operations can be followed by one performance of GFMUL64 for a reduction.

Operations 1 and 2 can generate RES′=(A*B mod P)′ as follows. Inputs can include A′, B′, K′, and Q′, where A′=bitreflected(A) or A′=X XOR C, B′=bitreflected(B) or B′=precomputed H value, K′=bitreflected(B1*Q+B0*x⁶⁴) and can be precomputed, and Q′=0xC2000000_00000000 or Q′ bitreflected version of Q, where Q=x⁷+x²+x+1 (x¹²⁸ mod P). An output can be a bit reflected result, RES′=(A*B mod P)′.

Operation 1 can compute C′=A′*B′. For example, A′ can be expressed as A′1*x⁶⁴+A′0, B′ can be expressed as B′1*x⁶⁴+B′0, and K′ can be expressed as K′1*x⁶⁴±K′0, where A′1=upper 64 bits of A′, A′0=lower 64 bits of A′, B′1=upper 64 bits of B′, and B′0=lower 64 bits of B′. A′*B′ can be computed as a sum of A′1B′1=GFMUL64(A′1, B′1), A′0K′1=GFMUL64(A′0, K′1), A′1B′0=GFMUL64(A′1, B′0), and A′0K′0=GFMUL64(A′0, K′0). Accordingly, C′=A′1B′1*x⁶⁴+A′0K′1*x⁶⁴+A′1B′0+A′0K′0, where C is a 192-bit number. In another expression, C′=C′H*x⁶⁴+C′L, where C′H=upper 128 bits of C′ and C′L=lower 64 bits of C′.

Operation 2 can fold C′L to generate a bit-reflected result RES′=C′H+GFMUL64(C′L, Q′)+C′L*x⁶⁴.

Table 1 below shows a comparison of operations for a reduction operation. As shown, use of PCLMULQDQ instructions to perform in accordance with the process of FIG. 4. Fewer instructions can be executed to perform reduction using the process of FIG. 4.

TABLE 1

| Shift-based reduction | PCLMULQDQ-based reduction |
|---|---|
| first phase of the reduction | first phase of the reduction |
| movdqa T2, GH | movdqa %% T3, [POLY2 wrt rip] |
| movdqa T3, GH | movdqa %% T2, %% T3 |
| movdqa T4, GH | pclmulqdq %% T2, %% GH, 0x01 |
| pslld T2, 31 | pslldq %% T2, 8 |
| pslld T3, 30 | pxor %% GH, %% T2 |
| pslld T4, 25 | second phase of the reduction |
| pxor T2, T3 | movdqa %% T2, %% T3 |
| pxor T2, T4 | pclmulqdq %% T2, %% GH, 0x00 |
| movdqa T5, T2 | psrldq %% T2, 4 |
| psrldq T5, 4 | pclmulqdq %% GH, %% T3, 0x01 |
| pslldq T2, 12 | pslldq %% GH, 4 |
| pxor GH, T2 | pxor %% GH, %% T2 |
| second phase of the reduction | pxor %% GH, %% T1 |
| movdqa T2, GH | |
| movdqa T3, GH | |
| movdqa T4, GH | |
| psrld T2, 1 | |
| psrld T3, 2 | |
| psrld T4, 7 | |
| pxor T2, T3 | |
| pxor T2, T4 | |
| pxor T2, T5 | |
| pxor GH, T2 | |
| pxor GH, T1 | |

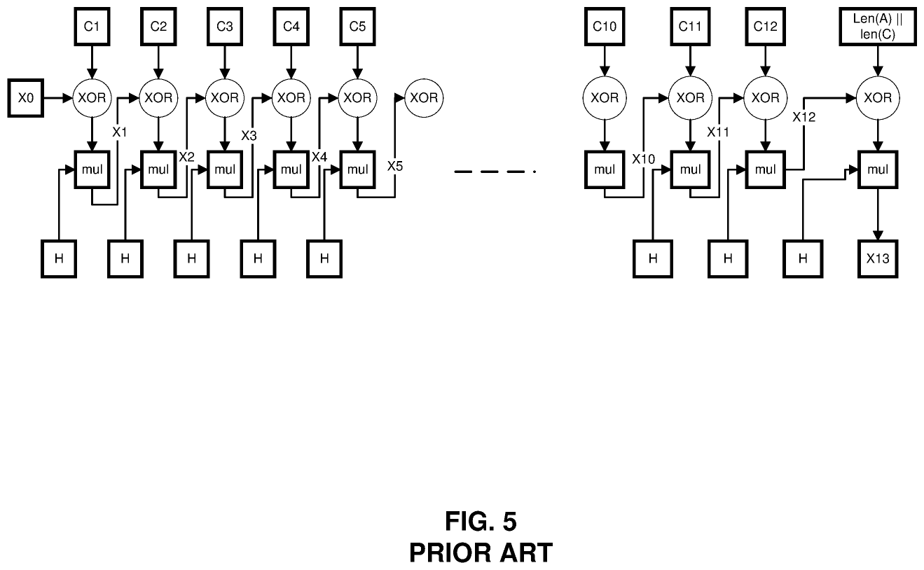

FIG. 5 depicts an example GHASH operation with 12 ciphertext blocks (Ci). The equation for X12 or X₁₂, where m+n=12, but could be other values, can be re-written as:

$$X 12 = X 0 * {H}^{12} + {\sum }_{i = 1}^{12} Ci * {H}^{13 - i}$$

In this equation, summation corresponds to XOR and * corresponds to multiplication (mul) in GF(2¹²⁸), based on GCM. This equation can be rewritten as:

X12=X0*H¹²+C1*H¹²+C2*H¹¹+C3*H¹⁰+C4*H⁹+C5*H⁸+C6*H⁷+C7*H⁶+C8*H⁵+C9*H⁴+C10*H³+C11*H²+C12*H¹

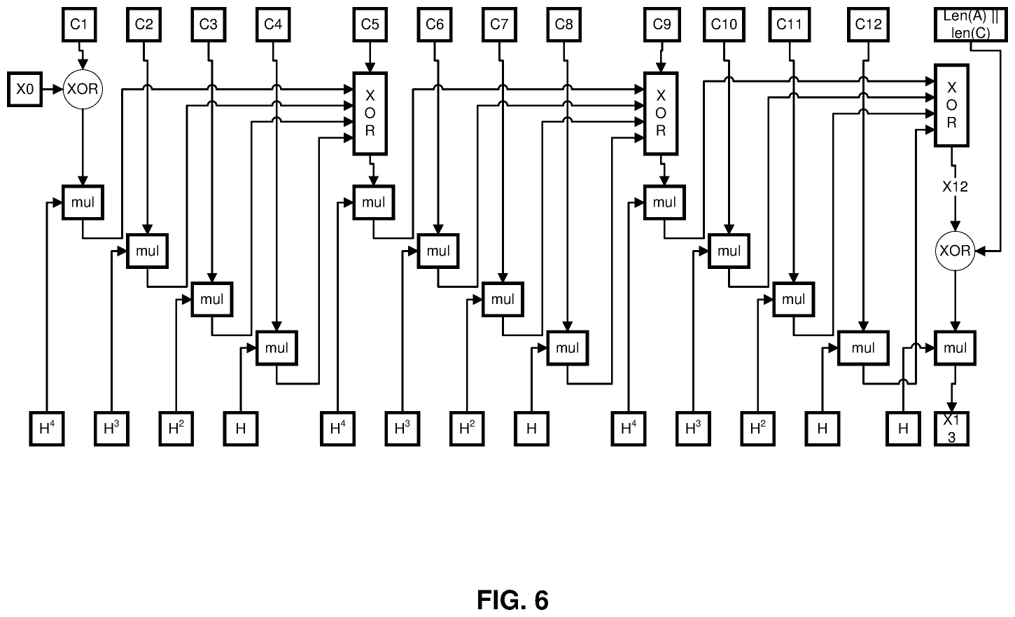

FIG. 6 depicts GHASH as a serial operation. Various examples provide a new equation to determine X12 as follows:

X12=(((((X0+C1)*H⁴+C2*H³+C3*H²+C4*H¹)+C5)*H⁴+C6*H³+C7*H²+C8*H¹)+C9*H⁴+C10*H³+C11*H²+C12*H¹

Powers of H can be precomputed allowing for parallelizing GHASH computation. For example, each of four multiplication operations can be performed in parallel. In a Single Instruction, Multiple Data (SIMD) setting, a register (e.g., ZMM) can hold four 128-bit blocks, and with a single execution, four parallel multiplication operations can be realized.

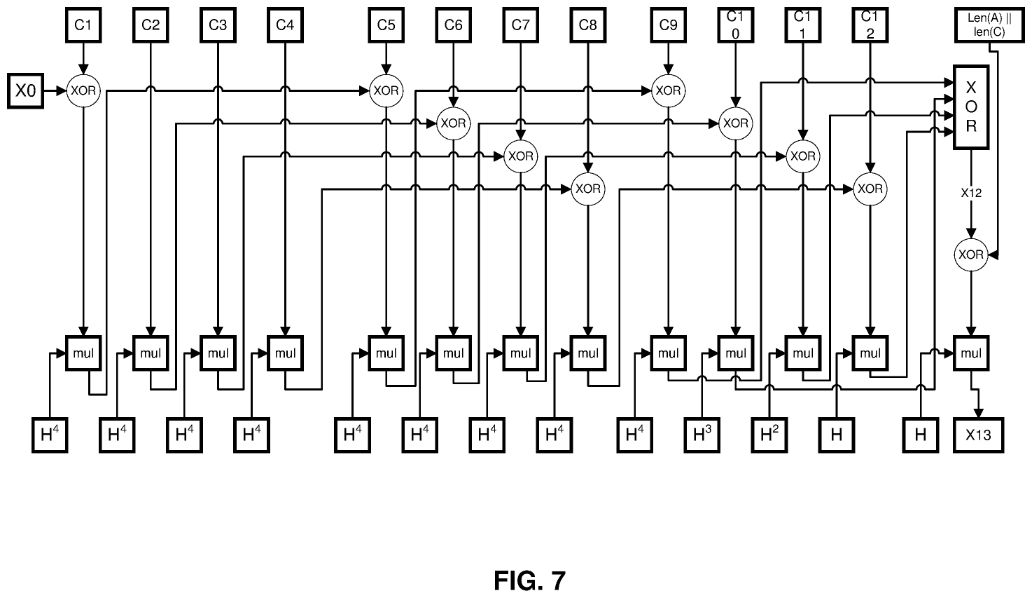

FIG. 7 depicts a GHASH operation. In a SIMD setting, four multiplication operations can be performed in parallel. After each of these four multiplication operations, 128-bit sections of the registers can be XORed together. Equation for X12 can be rewritten as follows:

X12=(((X0+C1)*H⁴+C5)*H⁴+C9)*H⁴+((C2*H⁴+C6)*H⁴+C10)*H³+((C3*H⁴+C7)*H⁴+C11)*H²+((C4*H⁴+C8)*H⁴+C12)*H¹

As can be seen, XORing sections of a ZMM register can be performed at a later operation of the computation. This method can be applied to increase speed of completion of SIMD operations on an arbitrary-length single buffer GHASH Operation (e.g., Advanced Vector Extensions (AVX), AVX2, AVX512 implementations).

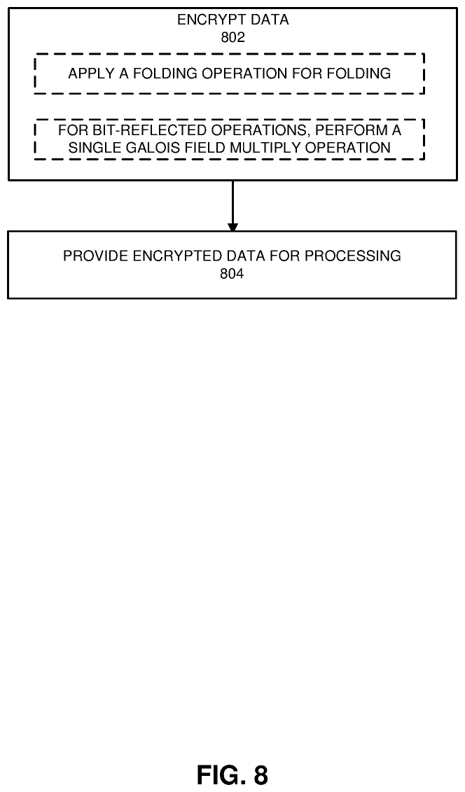

FIG. 8 depicts an example process. The process can be performed by one or more of: a processor, processor-executed microcode, an offload circuitry (e.g., accelerator) accessible to a process executed by the processor, network interface device, or other circuitry. At 802, based on receipt of data, a GHASH operation can be performed to encrypt the data. In some examples, the data can be transmitted in packets via Transport Layer Security (TLS) and/or Internet Protocol Security (IPsec) connections. For example, a folding operation can be performed to reduce a number of serial operations of a reduction operation in multiplication in GF(2¹²⁸). For example, for a GHASH operation over bit-reflected operands, for a reduction operation, one GFMUL64 operation can be performed.

At 804, the encrypted data can be stored for further processing. For example, the encrypted data can be stored and then transmitted in one or more packets to a receiver. For example, the encrypted data can be stored in memory for subsequent processing by a processor.

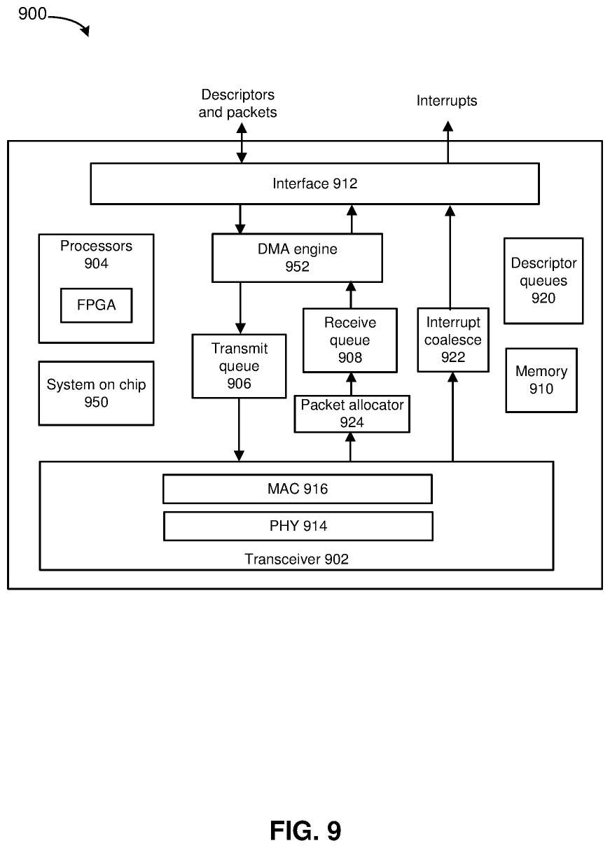

FIG. 9 depicts an example system that can perform GHASH operations. Network interface 900 can include transceiver 902, processors 904, transmit queue 906, receive queue 908, memory 910, and host interface 912, and DMA engine 952. Transceiver 902 can be capable of receiving and transmitting packets in conformance with the applicable protocols such as Ethernet as described in IEEE 802.3, although other protocols may be used. Transceiver 902 can receive and transmit packets from and to a network via a network medium (not depicted). Transceiver 902 can include PHY circuitry 914 and media access control (MAC) circuitry 916. PHY circuitry 914 can include encoding and decoding circuitry (not shown) to encode and decode data packets according to applicable physical layer specifications or standards.

MAC circuitry 916 can be configured to assemble data to be transmitted into packets, that include destination and source addresses along with network control information and error detection hash values.

Processors 904 and/or system on chip (SoC) 950 can include any a combination of: processor, core, graphics processing unit (GPU), field programmable gate array (FPGA), application specific integrated circuit (ASIC), or other programmable hardware device that allow programming of network interface 900. For example, a “smart network interface” can provide packet processing capabilities in the network interface using processors 904 or SoC 950. For example, processors 904 and/or or SoC 950 can perform GHASH per encrypted message based on multiplication and reduction operations, described herein. For example, a “smart network interface” can provide packet processing capabilities in the network interface using processors 904.

Packet allocator 924 can provide distribution of received packets for processing by multiple CPUs or cores using timeslot allocation described herein or RSS. When packet allocator 924 uses RSS, packet allocator 924 can calculate a hash or make another determination based on contents of a received packet to determine which CPU or core is to process a packet.

Interrupt coalesce 922 can perform interrupt moderation whereby network interface interrupt coalesce 922 waits for multiple packets to arrive, or for a time-out to expire, before generating an interrupt to host system to process received packet(s). Receive Segment Coalescing (RSC) can be performed by network interface 900 whereby portions of incoming packets are combined into segments of a packet. Network interface 900 provides this coalesced packet to an application.

Direct memory access (DMA) engine 952 can copy a packet header, packet payload, and/or descriptor directly from host memory to the network interface or vice versa, instead of copying the packet to an intermediate buffer at the host and then using another copy operation from the intermediate buffer to the destination buffer.

Memory 910 can be any type of volatile or non-volatile memory device and can store any queue or instructions used to program network interface 900. Transmit queue 906 can include data or references to data for transmission by network interface. Receive queue 908 can include data or references to data that was received by network interface from a network. Descriptor queues 920 can include descriptors that reference data or packets in transmit queue 906 or receive queue 908. Host interface 912 can provide an interface with host device (not depicted). For example, host interface 912 can be compatible with PCI, PCI Express, PCI-x, Serial ATA, and/or USB compatible interface (although other interconnection standards may be used).

In some examples, network interface and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

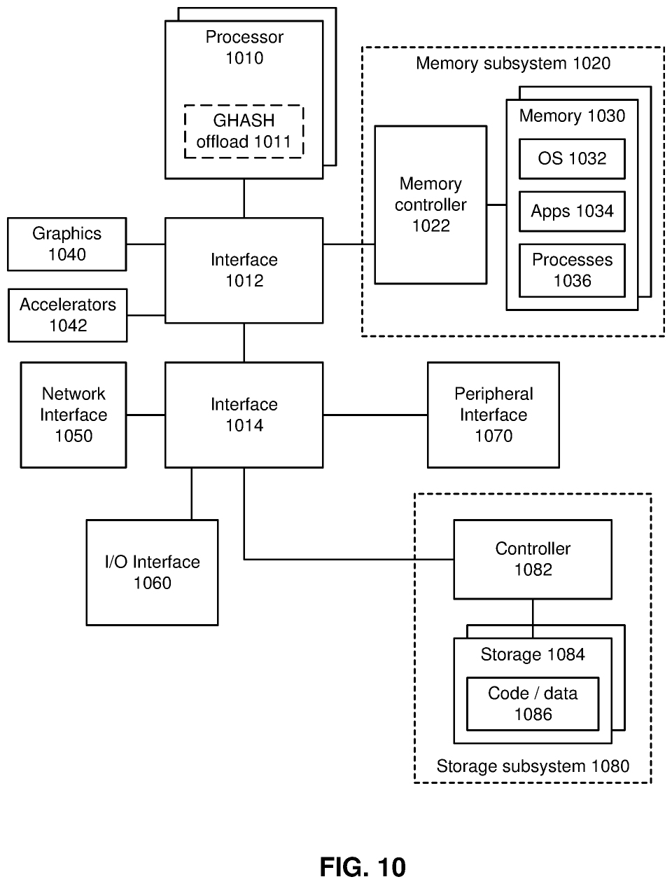

FIG. 10 depicts a system. The system can use examples to perform GHASH per encrypted message based on multiplication and reduction operations, as described herein. In some examples, GHASH offload 1011 accessible to a processor 1010, graphics 1040, one or more of accelerators 1042, and/or network interface 1050 can perform GHASH per encrypted message based on multiplication and reduction operations, described herein. System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die.

Accelerators 1042 can be a fixed function or programmable offload engine that can be accessed or used by a processor 1010. For example, an accelerator among accelerators 1042 can provide compression (DC) capability, cryptography services such as public key encryption (PKE), cipher, hash/authentication capabilities, decryption, or other capabilities or services. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as static random-access memory (SRAM), dynamic random-access memory (DRAM), or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

In some examples, OS 1032 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 1032 or driver for network interface 1050 or firmware executed by network interface 1050 can enable or disable network interface 1050 indicating support for selecting a polynomial and/or seed to generate a training signal for training multiple lanes. In some examples, OS 1032 or driver for network interface 1050 or firmware executed by network interface 1050 can utilize less than a full set of features supported by network interface 1050 such as using a strict subset of polynomials and/or seed values, described herein.

In some examples, network interface 1050 can be configured by OS 1032 or driver to select a polynomial and/or seed to generate a training signal for training multiple lanes. Network interface 1050 can advertise capability to select a polynomial and/or seed to generate a training signal for training multiple lanes. In some examples, PMD circuitry of network interface 1050 can generate polynomials for the first lane to fourth lane also to generate polynomials for the fifth lane to eighth lane.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. In some examples, network interface 1050 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory.

Some examples of network interface 1050 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 1050 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™ Data Plane Development Kit (DPDK), OpenDataPlane (ODP), Infrastructure Programmer Development Kit (IPDK), x86 compatible executable binaries or other executable binaries, or others.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. A non-volatile memory (NVM) device is a memory whose state is determinate even if power is interrupted to the device.

In an example, system 1000 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chip-to-chip communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: an interface and circuitry, coupled to the interface, to perform cryptographic operations on packets based on Advanced Encryption Standard with Galois/Counter Mode (AES-GCM) hash (GHASH), wherein the cryptographic operations comprise a reduction operation and wherein the reduction operation comprises a single Galois territory multiplication 64 bit operation.

Example 2 includes one or more examples, wherein the reduction operation comprises a folding operation.

Example 3 includes one or more examples, wherein the cryptographic operations are utilized for encrypted communications based on Transport Layer Security (TLS) or Internet Protocol Security (IPSec).

Example 4 includes one or more examples, wherein the cryptographic operations utilize bit-reflected operands.

Example 5 includes one or more examples, wherein to perform the cryptographic operations, the circuitry is to perform multiplication in Galois Field GF(2¹²⁸) by four Galois territory multiplication 64 bit operations followed by one Galois territory multiplication 64 bit operation for the reduction operation.

Example 6 includes one or more examples, wherein to perform the cryptographic operations, the circuitry is to perform a parallelized GHASH operation on register contents in a Single Instruction/Multiple Data (SIMD) setting.

Example 7 includes one or more examples, and includes a network interface device comprising: a host interface; a direct memory access (DMA) circuitry; a network interface; and the circuitry, wherein the circuitry is to perform the GHASH operations for packet communications.

Example 8 includes one or more examples, and includes a central processing unit (CPU), wherein the circuitry comprises an accelerator device coupled to the CPU.

Example 9 includes one or more examples, wherein to perform the cryptographic operations, the circuitry is to perform at least one carryless multiply operation.

Example 10 includes one or more examples, and includes a method that includes: performing cryptographic operations on a packet based on Advanced Encryption Standard with Galois/Counter Mode (AES-GCM) hash (GHASH), wherein the cryptographic operations comprise a reduction operation and wherein the reduction operation comprises a single Galois territory multiplication 64 bit operation.

Example 11 includes one or more examples, wherein the reduction operation comprises a folding operation.

Example 12 includes one or more examples, and includes transmitting the packet based on Transport Layer Security (TLS) or Internet Protocol Security (IPSec).

Example 13 includes one or more examples, wherein the cryptographic operations utilize bit-reflected operands.

Example 14 includes one or more examples, and includes a non-transitory computer-readable medium comprising instructions, that if executed by circuitry, cause the circuitry to: configure circuitry to perform cryptographic operations on packets based on Advanced Encryption Standard with Galois/Counter Mode (AES-GCM) hash (GHASH), wherein the cryptographic operations comprise a reduction operation and wherein the reduction operation comprises a single Galois territory multiplication 64 bit operation.

Example 15 includes one or more examples, wherein the reduction operation comprises a folding operation.

Example 16 includes one or more examples, wherein to perform the cryptographic operations, the circuitry is to perform multiplication in Galois Field GF(2¹²⁸) by four Galois territory multiplication 64 bit operations followed by one Galois territory multiplication 64 bit operation for the reduction operation.

Example 17 includes one or more examples, wherein to perform the cryptographic operations, the circuitry is to perform a parallelized GHASH operation on register contents in a Single Instruction/Multiple Data (SIMD) setting.

Example 18 includes one or more examples, wherein the circuitry comprises one or more of: a central processing unit (CPU), CPU-executed microcode, an accelerator, or a network interface device.

Example 19 includes one or more examples, wherein to perform cryptographic operations on packets, the circuitry is to execute at least one Advanced RISC Machines (ARM) VMULL.P8 instruction.

Example 20 includes one or more examples, wherein to perform cryptographic operations on packets, the circuitry is to execute at least one Intel® AES-NI PCLMULQDQ instruction.

1. An apparatus comprising:
an interface and
circuitry, coupled to the interface, to perform cryptographic operations on packets based on Advanced Encryption Standard with Galois/Counter Mode (AES-GCM) hash (GHASH), wherein the cryptographic operations comprise a reduction operation and wherein the reduction operation comprises a single Galois territory multiplication 64 bit operation.

2. The apparatus of claim 1, wherein the reduction operation comprises a folding operation.

3. The apparatus of claim 1, wherein the cryptographic operations are utilized for encrypted communications based on Transport Layer Security (TLS) or Internet Protocol Security (IPSec).

4. The apparatus of claim 1, wherein the cryptographic operations utilize bit-reflected operands.

5. The apparatus of claim 1, wherein to perform the cryptographic operations, the circuitry is to perform multiplication in Galois Field GF(2¹²⁸) by four Galois territory multiplication 64 bit operations followed by one Galois territory multiplication 64 bit operation for the reduction operation.

6. The apparatus of claim 1, wherein to perform the cryptographic operations, the circuitry is to perform a parallelized GHASH operation on register contents in a Single Instruction/Multiple Data (SIMD) setting.

7. The apparatus of claim 1, comprising a network interface device comprising:
a host interface;
a direct memory access (DMA) circuitry;
a network interface; and
the circuitry, wherein the circuitry is to perform the GHASH operations for packet communications.

8. The apparatus of claim 1, comprising a central processing unit (CPU), wherein the circuitry comprises an accelerator device coupled to the CPU.

9. The apparatus of claim 1, wherein to perform the cryptographic operations, the circuitry is to perform at least one carryless multiply operation.

10. A method comprising:
performing cryptographic operations on a packet based on Advanced Encryption Standard with Galois/Counter Mode (AES-GCM) hash (GHASH), wherein the cryptographic operations comprise a reduction operation and wherein the reduction operation comprises a single Galois territory multiplication 64 bit operation.

11. The method of claim 10, wherein the reduction operation comprises a folding operation.

12. The method of claim 10, comprising:
transmitting the packet based on Transport Layer Security (TLS) or Internet Protocol Security (IPSec).

13. The method of claim 10, wherein the cryptographic operations utilize bit-reflected operands.

14. A non-transitory computer-readable medium comprising instructions, that if executed by circuitry, cause the circuitry to:
configure circuitry to perform cryptographic operations on packets based on Advanced Encryption Standard with Galois/Counter Mode (AES-GCM) hash (GHASH), wherein the cryptographic operations comprise a reduction operation and wherein the reduction operation comprises a single Galois territory multiplication 64 bit operation.

15. The computer-readable medium of claim 14, wherein the reduction operation comprises a folding operation.

16. The computer-readable medium of claim 14, wherein to perform the cryptographic operations, the circuitry is to perform multiplication in Galois Field GF(2¹²⁸) by four Galois territory multiplication 64 bit operations followed by one Galois territory multiplication 64 bit operation for the reduction operation.

17. The computer-readable medium of claim 14, wherein to perform the cryptographic operations, the circuitry is to perform a parallelized GHASH operation on register contents in a Single Instruction/Multiple Data (SIMD) setting.

18. The computer-readable medium of claim 16, wherein the circuitry comprises one or more of: a central processing unit (CPU), CPU-executed microcode, an accelerator, or a network interface device.

19. The computer-readable medium of claim 16, wherein to perform cryptographic operations on packets, the circuitry is to execute at least one Advanced RISC Machines (ARM) VMULL.P8 instruction.

20. The computer-readable medium of claim 16, wherein to perform cryptographic operations on packets, the circuitry is to execute at least one Intel® AES-NI PCLMULQDQ instruction.
